(19) United States
(12) Patent Application Publication
(10) Pub. No.: US 2025/0125381 A1
(43) Pub. Date: Apr. 17, 2025

(54) Catalyst Electrode and Method for Manufacturing Catalyst Electrode

(71) Applicant: SK Innovation Co., Ltd., Seoul (KR)

(72) Inventors: Soo Bean Kim, Daejeon (KR); Hyun Su Han, Daejeon (KR); Tae Kyoung Lee, Daejeon (KR); Tae Hong Seok, Daejeon (KR); Yun Ji Lim, Daejeon (KR)

(21) Appl. No.: 18/912,751

(22) Filed: Oct. 11, 2024

(30) Foreign Application Priority Data
Oct. 13, 2023 (KR) 10-2023-0136617

(51) Int. Cl. H01M 4/92; C25B 11/063; C25B 11/081; H01M 4/88; H01M 8/1004

(52) U.S. Cl. CPC H01M 4/925; C25B 11/063; C25B 11/081; H01M 4/8853; H01M 8/1004

(57) ABSTRACT

A catalyst electrode including a metal layer and a catalyst layer formed on the metal layer is provided. The catalyst layer includes iridium and palladium. A membrane electrode assembly and a method for manufacturing a catalyst electrode are also provided.

### CROSS-REFERENCE TO RELATED APPLICATION

This application claims priority to Korean Patent Application No. 10-2023-0136617 filed Oct. 13, 2023, the disclosure of which is hereby incorporated by reference in its entirety.

### BACKGROUND OF THE INVENTION

### 1. Field of the Invention

Embodiments of the present disclosure relate to a catalyst electrode and a method for manufacturing the catalyst electrode.

### 2. Description of Related Art

Hydrogen energy is clean energy and is attracting attention as one of the promising forms of alternative energy to solve energy problems in the long term. Among hydrogen production methods, the water electrolysis method, which uses electrical energy to separate water into hydrogen and oxygen and which does not emit carbon dioxide, is receiving much attention because it is eco-friendly, and is expected to greatly contribute to the achievement of carbon neutrality.

Meanwhile, water electrolysis reactions include oxygen evolution reaction (OER) and hydrogen evolution reaction (HER), wherein the OER occurs at the oxygen evolution electrode and the HER occurs at the hydrogen evolution electrode. The OER and the HER are shown in Formula 1 below.

Oxygen evolution reaction: 2H₂O→4H⁺+O₂+4e⁻

Hydrogen evolution reaction: 4H⁺+4e⁻>2H₂

Overall reaction: 2H₂O→2H₂+O₂ Formula 1

In particular, in the water electrolysis reaction, an overpotential higher than the theoretical OER voltage occurs due to a slower reaction rate of the OER than that of the HER. Thus, in order to improve the performance of a water electrolysis system, it is necessary to develop a high-efficiency catalyst lowering the overpotential of the OER which requires a high overpotential.

### SUMMARY OF THE INVENTION

Embodiments of the present disclosure may provide a catalyst electrode with improved OER performance, a method for manufacturing the catalyst electrode, and a membrane electrode assembly.

A catalyst electrode according to an embodiment of the present disclosure comprises a metal layer; and a catalyst layer formed on the metal layer, wherein the catalyst layer comprises iridium and palladium. In one embodiment, the catalyst electrode contains iridium and palladium in the catalyst layer at a loading amount of iridium ranging from 0.02 to 0.8 mg/cm², and at a loading amount of palladium ranging from 0.1 to 0.9 mg/cm².

In one embodiment, at least a part of the iridium and palladium comprised in the catalyst layer may be chemically bonded with each other.

In one embodiment, the metal layer may comprise one or more selected from the group consisting of a metal mesh, metal foam, metal foil, metal felt, and metal fiber.

In one embodiment, the metal layer may comprise one or more metals or metal alloy selected from the group consisting of titanium, nickel, and stainless steel.

In one embodiment, the iridium and palladium may be electrochemically deposited on the metal layer.

In one embodiment, the iridium and palladium may be in direct contact with the metal layer.

In one embodiment, the catalyst layer may not include a binder.

A method for manufacturing a catalyst electrode according to an embodiment of the present disclosure comprises a step of depositing iridium and palladium on a metal substrate.

In one embodiment, the step of depositing iridium and palladium on a metal substrate may comprise a step of inputting the metal substrate to a solution including an iridium precursor and a palladium precursor; and a step of electrochemically depositing the iridium and palladium on the metal layer.

In one embodiment, at least a part of the iridium and palladium deposited on the metal substrate may be chemically bonded with each other.

In one embodiment, the step of electrochemically depositing the iridium and palladium on the metal layer may be performed by applying a voltage through one or more electrodes in contact with the solution.

In one embodiment, the voltage may be increased at a constant rate.

In one embodiment, the method for manufacturing a catalyst electrode may further comprise a step of heat-treating the metal substrate with deposited iridium and palladium.

In one embodiment, the method for manufacturing a catalyst electrode may further comprise a step of acid-treating the metal substrate before the step of depositing iridium and palladium on a metal substrate.

A membrane electrode assembly according to one embodiment of the present disclosure may comprise an electrolyte membrane; an anode positioned on one surface of the electrolyte membrane; and a cathode positioned on the other surface of the electrolyte membrane, wherein the anode may comprise: a metal layer; and a catalyst layer formed on the metal layer and comprising iridium and palladium.

The present disclosure further provides a use of the catalyst electrode for being comprised in a water electrolysis device or in a fuel cell.

According to the present disclosure, a catalyst electrode with improved OER performance, a method for manufacturing the catalyst electrode, and a membrane electrode assembly can be provided.

### BRIEF DESCRIPTION OF THE DRAWINGS

FIG. 1 shows a diagram for explaining a catalyst electrode according to one embodiment of the present disclosure.

FIG. 2 shows a flowchart for explaining a method for manufacturing a catalyst electrode according to one embodiment of the present disclosure.

FIG. 3 shows a diagram for explaining an example of an electrochemical system used in a method for manufacturing a catalyst electrode according to one embodiment of the present disclosure.

FIG. 4 shows scanning electron microscope (SEM) images of a catalyst electrode according to one embodiment of the present disclosure.

FIG. 5 shows energy dispersive spectrometer (EDS) mapping images of a catalyst electrode according to one embodiment of the present disclosure.

FIG. 6 is a graph showing the results of an X-ray diffraction (XRD) analysis of catalyst electrodes according to one embodiment and comparative examples of the present disclosure.

FIGS. 7 and 8 are graphs showing the results of an X-ray photoelectron spectroscopy (XPS) analysis of catalyst electrodes according to one embodiment and comparative examples of the present disclosure.

FIG. 9 is a graph showing the embedded amount of iridium metal as measured by performing an inductively coupled plasma atomic emission spectroscopy (ICP-AES) analysis with catalyst electrodes according to one embodiment and comparative examples of the present disclosure.

FIG. 10 is a graph showing OER performance of catalyst electrodes according to one embodiment and comparative examples of the present disclosure.

### DESCRIPTION OF THE INVENTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the specification of application. In addition, the technical principle of the present invention is not construed as being limited to the embodiments described in the present specification or application.

Hereinafter, the present invention will be described in detail with reference to the accompanying drawing. However, those skilled in the art will appreciate that such embodiments described with reference to the accompanying drawing are provided to further understand the spirit of the present invention and do not limit subject matters to be protected as disclosed in the detailed description and appended claims.

Furthermore, throughout the disclosure, unless otherwise particularly stated, the word “comprise”, “include”, “contain”, or “have” does not mean the exclusion of any other constituent element, but means further inclusion of other constituent elements, and elements, materials, or processes which are not further listed are not excluded.

Unless the context clearly indicates otherwise, the singular forms of the terms used in the present specification may be interpreted as including the plural forms. As used herein, the singular form of “a”, “an”, and “the” include plural referents unless the context clearly states otherwise.

The numerical range used in the present disclosure comprises all values within the range comprising the lower limit and the upper limit, increments logically derived in a form and spanning in a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present disclosure. Unless otherwise defined in the present disclosure, values which may be outside a numerical range due to experimental error or rounding off of a value are also comprised in the defined numerical range.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Hereinafter, unless otherwise particularly defined in the present disclosure, “about” may be considered as a value within 30%, 25%, 20%, 15%, 10%, 5%, 3%, 2%, 1%, 0.5%, 0.1%, 0.05% or 0.01% of a stated value. Unless indicated to the contrary, the numerical parameters set forth in this disclosure are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

### Catalyst Electrode

In one aspect of the present disclosure, provided is a catalyst electrode comprising a metal layer; and a catalyst layer formed on the metal layer, wherein the catalyst layer comprises iridium and palladium.

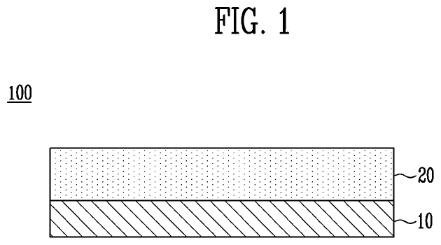

FIG. 1 shows a diagram for explaining a catalyst electrode according to one embodiment of the present disclosure. Hereinafter, a catalyst electrode according to an embodiment of the present disclosure will be described with reference to FIG. 1.

Referring to FIG. 1, a catalyst electrode 100 comprises a metal layer 10 and a catalyst layer 20.

A metal layer 10 may function as a metal substrate on which a catalyst metal is deposited, and in one embodiment, a metal layer 10 may comprise one or more selected from the group consisting of a metal mesh, metal foam, metal foil, metal felt, and metal fiber. In addition, in one embodiment, the metal layer 10 may comprise one or more metals or metal alloy selected from the group consisting of titanium, nickel, and stainless steel. For example, the metal layer 10 may comprise a titanium mesh, but is not limited thereto.

A catalyst layer 20 is formed on the metal layer 10 and comprises iridium and palladium. The catalyst layer 20 may comprise iridium and palladium in one layer, as further described later; or the catalyst layer 20 may comprise silver and iridium in separate layers, respectively. In an embodiment, iridium and palladium may be deposited on the metal layer 10 by an electrochemical method. In an embodiment, at least a part of iridium and palladium comprised in the catalyst layer 20 may be chemically bonded to each other. In other words, as at least a part of iridium and palladium comprised in the catalyst layer 20 is chemically bonded to each other, such that the electronic structure of at least a part of the iridium and palladium comprised in the catalyst layer 20 may be changed. As the electronic structure of at least a part of the iridium and palladium comprised in the catalyst layer 20 is changed, in particular, as the electronic structure of at least a part of the iridium comprised in the catalyst layer 20 is changed, the activity of the catalyst electrode 100 for oxygen evolution reaction (OER) may be improved, and as a result, the OER performance of the catalyst electrode 100 may be improved.

In an embodiment, iridium and palladium comprised in the catalyst layer 20 may be in direct contact with the metal layer 10. In other words, as described above, iridium and palladium may be directly deposited on the metal layer 10 through an electrochemical method, and a chemical bond may be formed between the metal layer 10 and a catalyst layer 20. Accordingly, electron transfer performance and durability of a catalyst electrode 100 may be improved.

In an embodiment, the catalyst layer 20 may not comprise a binder. As described above, iridium and palladium may be deposited directly on the metal layer 10 through an electrochemical method, and a chemical bond may be formed between the metal of the metal layer 10 and the catalyst layer 20, so such that the catalyst layer 20 may be formed on the metal layer 10 without using a separate binder.

The commonly used Nafion binder is a PFAS (Per-and polyfluoroalkyl substances), which can cause environmental issues, and there is a problem of reduced activity and reduced durability due to degradation of the Nafion binder during the electrode reaction. Also, the catalyst layer 20 can be directly deposited on the current collector (metal layer 10) without the use of a binder, which increases the chemical bonding between the current collector (metal layer 10) and the catalyst layer 20, thereby improving electron-transferability and durability.

The catalyst electrode 100 according to an embodiment of the present disclosure may have an oxygen evolution performance equal to or even better than that of a conventional noble metal catalyst electrode, with only a small metal loading amount as compared to a conventionally used noble metal catalyst electrode.

A catalyst electrode 100 according to an embodiment of the present disclosure may be comprised in a water electrolysis device or may be comprised in a fuel cell, but the use of the catalyst electrode 100 is not limited thereto.

### Method for Manufacturing Catalyst Electrode

In another aspect of the present disclosure, provided is a method for manufacturing a catalyst electrode 100, comprising a step of depositing iridium and palladium on a metal substrate.

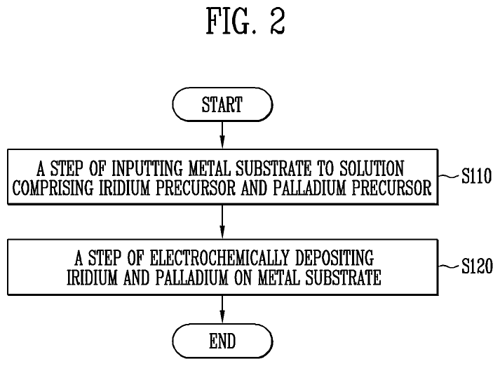

FIG. 2 shows a flowchart explaining a method for manufacturing a catalyst electrode 100 according to one embodiment of the present disclosure. Hereinafter, a method for manufacturing a catalyst electrode 100 according to an embodiment of the present disclosure will be described with reference to FIG. 2.

A method for manufacturing a catalyst electrode 100 according to another embodiment of the present disclosure comprises a step of depositing iridium and palladium on a metal substrate. The metal substrate may be a feature that is identical to the above-described metal layer 10, and accordingly, in an embodiment, the metal layer 10 may comprise one or more selected from the group consisting of a metal mesh, metal foam, metal foil, metal felt, and metal fiber, and in one embodiment, the metal layer 10 may comprise one or more metals or metal alloy selected from the group consisting of titanium, nickel, and stainless steel.

Referring to FIG. 2, the step of depositing iridium and palladium on a metal substrate may comprise a step of inputting the metal substrate to a solution comprising an iridium precursor and a palladium precursor (S110 operation); and a step of electrochemically depositing the iridium and palladium on the metal substrate (S120 operation).

In one embodiment, the iridium precursor may be an iridium salt. For example, the iridium salt may be one or more selected from the group consisting of iridium chloride, an iridium chloride hydrate, iridium bromide, iridium acetylacetonate, hexachloroiridic acid, sodium hexachloroiridate, and potassium hexachloroiridate, but is not limited thereto.

In one embodiment, the palladium precursor may be a palladium salt. For example, the palladium salt may be one or more selected from the group consisting of palladium nitrate, palladium chloride, palladium bromide, palladium sulfate, palladium acetylacetonate, palladium iodide, palladium acetate, palladium propionate, palladium dicyanide, palladium trifluoroacetate, ethylenediamine palladium chloride, and palladium hexafluoroacetylacetonate, but is not limited thereto.

In one embodiment, the solution comprising the iridium precursor and the palladium precursor may comprise an acidic solvent in consideration of dissolution of the iridium precursor and the palladium precursor. When the pH of the solution comprising the iridium precursor and the palladium precursor is relatively high, deposition efficiency may be reduced due to the formation of metal precipitates. The strongly acidic solvent may be, for example, a sulfuric acid solution, but is not limited thereto.

A step of electrochemically depositing the iridium and palladium on the metal substrate (S120 operation) may be performed by applying voltage through one or more electrodes in contact with the solution comprising the iridium precursor and the palladium precursor.

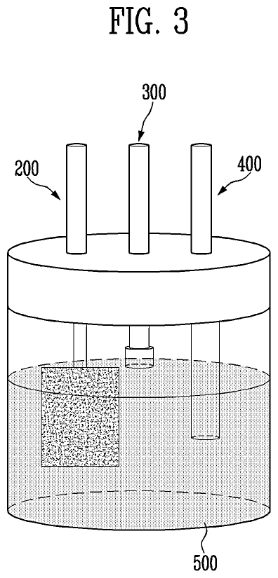

In one embodiment, the step of electrochemically depositing iridium and palladium on the metal substrate may be performed using a two-electrode electrochemical system. For example, one or more electrodes in contact with the solution comprising the iridium precursor and the palladium precursor may comprise a working electrode and a reference electrode. In another embodiment, the step of electrochemically depositing iridium and palladium on the metal substrate may be performed using a three-electrode electrochemical system. For example, one or more electrodes in contact with the solution comprising the iridium precursor and the palladium precursor may comprise a working electrode, a counter electrode, and a reference electrode. An exemplary three-electrode electrochemical system is provided in FIG. 3, and the electrochemical system in FIG. 3 comprises a working electrode 200, a reference electrode 300, and a counter electrode 400, which are in contact with the solution 500 comprising the iridium precursor and the palladium precursor, which functions as an electrolyte.

In the three-electrode electrochemical system, the working electrode may be an electrode where an electrochemical reaction occurs, the counter electrode may be an electrode that completes an electrical circuit so that charges may move in an electrochemical system, and the reference electrode may be an electrode serving as a reference for measuring the potential of the working electrode. In the two-electrode electrochemical system, the reference electrode may also serve as the counter electrode. That is, since an electrochemical reaction occurs at the working electrode, the working electrode may comprise a metal substrate on which iridium and palladium are deposited.

In an embodiment, the voltage may be applied to the working electrode and the reference electrode in the two-electrode electrode system. In another embodiment, the voltage may be applied to the working electrode, the reference electrode, and the counter electrode in the three-electrode system. As the voltage is applied, iridium and palladium from the solution comprising the iridium precursor and the palladium precursor may be deposited on the metal substrate comprised in the working electrode. In one embodiment, the magnitude of the applied voltage may gradually increase. In addition, in one embodiment, the magnitude of the applied voltage may increase at a constant rate. Upon applying the voltage, crystal nuclei of palladium and iridium metal ions may be nucleated on the metal substrate, and then, as the voltage of an increased magnitude is repeatedly applied, growth of the crystals occurs. Accordingly, iridium and palladium metals may be deposited uniformly and efficiently on the metal substrate.

In one embodiment, a step of acid-treating the metal substrate may be performed before the step of depositing iridium and palladium on the metal substrate. By the step of acid-treating, oxides or foreign substances formed on the metal substrate may be removed, and as a result, iridium and palladium ions may be effectively deposited on the metal substrate.

In addition, in one embodiment, the method may further comprise a step of heat-treating the metal substrate with deposited iridium and palladium, after the step of depositing iridium and palladium on the metal substrate. Accordingly, iridium and palladium deposited on the metal substrate may have a stable metal phase.

### Membrane Electrode Assembly

In another aspect of the present disclosure, provided is a membrane electrode assembly comprising an electrolyte membrane; an anode positioned on one surface of the electrolyte membrane; and a cathode positioned on the other surface of the electrolyte membrane, wherein the anode comprises: a metal layer 10; and a catalyst layer 20 formed on the metal layer 10 and comprising iridium and palladium.

A membrane electrode assembly provided in another aspect of the present disclosure may comprise the above-described catalyst electrode 100 as the anode. In other words, the anode may comprise a metal layer 10; and a catalyst layer 20 formed on the metal layer 10 and comprising iridium and palladium.

In addition, a membrane electrode assembly provided in another aspect of the present disclosure may comprise a cathode including a cathode catalyst, and the cathode catalyst may be a material commonly used in the art. For example, as the cathode catalyst, one single substance or a mixture of two or more substances selected the group consisting of platinum, ruthenium, iridium, osmium, palladium, platinum-ruthenium alloys, platinum-osmium alloys, platinum-palladium alloys, and oxides thereof may be used, but is not limited thereto.

In addition, a membrane electrode assembly provided in another aspect of the present disclosure may comprise an electrolyte membrane disposed between the anode and the cathode. For example, the electrolyte membrane may be a polymer electrolyte membrane comprising a fluorine-based polymer or a hydrocarbon-based polymer, but is not limited thereto.

A membrane electrode assembly provided in another aspect of the present disclosure may be comprised in a water electrolysis device or a fuel cell.

### EXAMPLES

Hereinafter, a catalyst electrode, a method for manufacturing catalyst electrode and a membrane electrode assembly according to the present disclosure will be described in more detail based on examples and comparative examples. However, the following examples and comparative examples are only examples to describe the present disclosure in more detail, and the present disclosure is not limited by the following examples and comparative examples.

### <Example 1>—Manufacturing of Ir—Pd/Ti Electrode

Iridium chloride and palladium nitrate were added to a 0.5 M sulfuric acid solution at a concentration of 200 μM and 400 μM, respectively, and ultrasonic treatment and stirring were performed until the added iridium chloride and palladium nitrate were completely dissolved.

To electrochemically deposit the prepared precursor solution on a working electrode, an electrochemical cell was used. The electrochemical cell consisted of the prepared precursor solution, a titanium mesh acid-treated with oxalic acid (5 wt. %) as the working electrode, a graphite rod as a counter electrode, and Ag/AgCl as a reference electrode.

The titanium mesh was immersed in the precursor solution with an area of 1 cm², and linear sweep voltammetry (LSV) was repeated 300 times at a scanning rate of 10 mV/s in a voltage range of 0.02 V to 0.17 V (vs reversible hydrogen electrode (RHE)) to deposit iridium and palladium on the titanium mesh, which was the working electrode. Finally, an iridium-palladium/titanium (Ir—Pd/Ti) electrode was manufactured by performing heat treatment at 300° C. for one hour in H₂ atmosphere.

### <Comparative Example 1>—Preparation of Ir/Ti Electrode

An electrode was manufactured in the same manner as in Example 1, except that the titanium mesh was immersed into an iridium precursor solution prepared without the palladium precursor. The iridium precursor solution included iridium chloride dissolved in a 0.5 M sulfuric acid solution at a concentration of 500 μM.

### <Comparative Example 2>—Preparation of Pd/Ti Electrode

An electrode was manufactured in the same manner as in Example 1, except that the titanium mesh was immersed into a palladium precursor solution prepared without adding the iridium precursor. The palladium precursor solution included palladium nitrate dissolved in a 0.5 M sulfuric acid solution at a concentration of 500 μM.

### Comparative Example 3>—Preparation of IrO₂ Electrode

IrO₂ black (100% by weight, Alfa Aesar), a commercial anode catalyst, was used to prepare an IrO₂ electrode.

### <Experimental Example 1>—Morphology Analysis of Electrode of Example 1

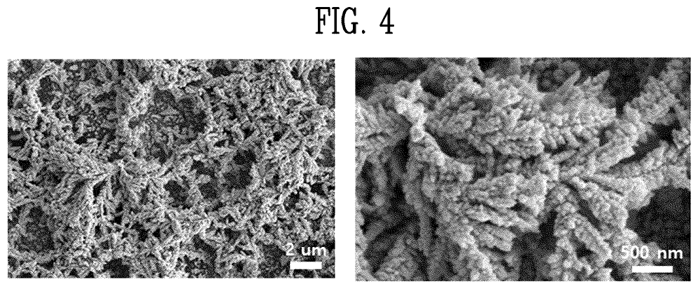

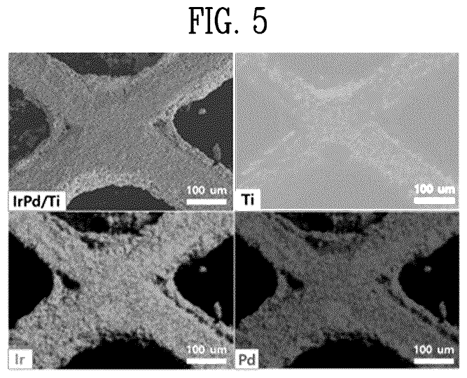

Using a scanning electron microscope (Apreo) equipped with an EDS detector, SEM images and EDS mapping analysis results for the electrode of Example 1 were obtained. The SEM images of the electrode of Example 1 are shown in FIG. 4, and the EDS mapping analysis results are shown in FIG. 5.

Referring to FIG. 4, it can be confirmed that a dendrite nanostructure was formed on the titanium mesh of the electrode of Example 1.

In addition, referring to FIG. 5, it can be confirmed that both iridium and palladium were present on the titanium mesh of the electrode of Example 1, and both iridium and palladium were deposited uniformly throughout the titanium mesh.

### <Experimental Example 2>—Analysis of Deposition Characteristics of Catalyst Layer in Electrodes

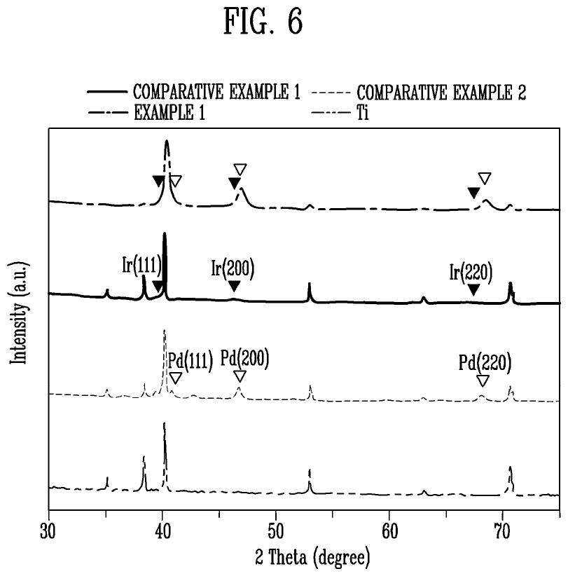

The metal crystal planes of the electrodes of Example 1, Comparative Example 1, and Comparative Example 2 were confirmed using X-ray diffraction (XRD; PANalytical). The measurement was performed at 40 kV and 100 mA using Cu Kα radiation in a range of 10° to 80° at a scan speed of 6° per minute at intervals of 0.01°, and the results are shown in FIG. 6.

Referring to FIG. 6, an iridium peak was observed in the XRD analysis results of the electrode of Comparative Example 1, and a palladium peak was observed in the XRD analysis results of the electrode of Comparative Example 2. Since both an iridium peak and a palladium peak were observed in the electrode of Example 1, it can be confirmed that both iridium and palladium were present in the catalyst layer deposited on the titanium mesh of the electrode of Example 1.

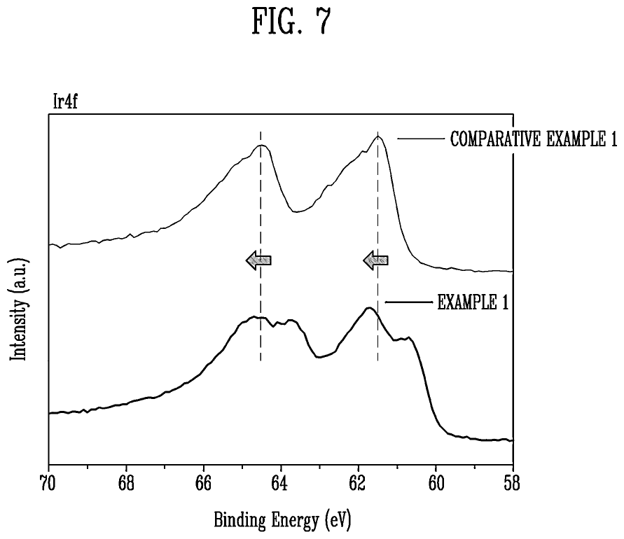

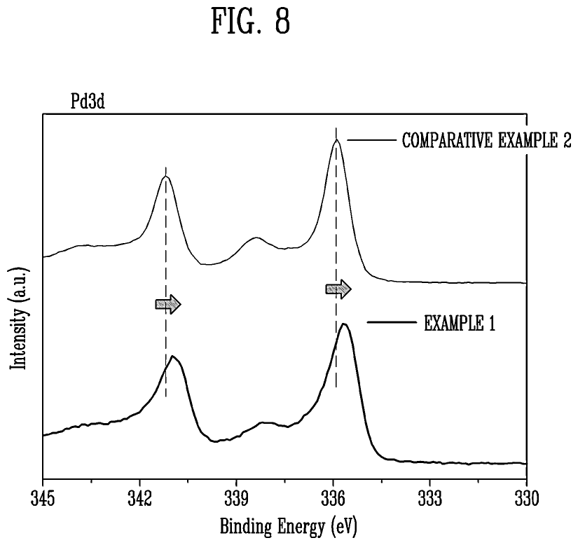

In addition, the electronic structure of the metal present on the electrode surface was confirmed through X-ray photoelectron spectroscopy (XPS) for the electrodes of Example 1, Comparative Example 1, and Comparative Example 2, and the results are shown in FIGS. 7 and 8.

Referring to FIG. 7, as a result of confirming the Ir4f peak of the electrode of Example 1 and the electrode of Comparative Example 1, since the peak of Example 1 shifted to the left compared to the peak of Comparative Example 1, it can be assumed that not only iridium but also palladium was present in the catalyst layer of the electrode of Example 1, and it can be seen that the electronic structure of iridium was changed due to the presence of palladium.

Referring to FIG. 8, as a result of confirming the Pd3d peak of the electrode of Example 1 and the electrode of Comparative Example 2, since the peak of Example 1 shifted to the right compared to the peak of Comparative Example 2, it can be assumed that not only palladium but also iridium was present in the catalyst layer of the electrode of Example 1, and it can be seen that the electronic structure of only was changed due to the presence of iridium.

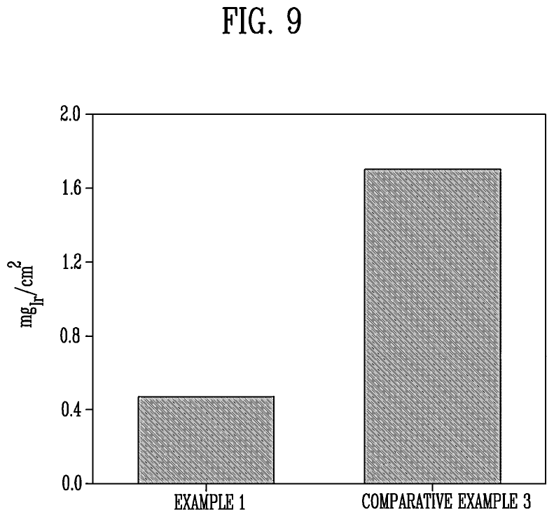

In addition, for the electrodes of Example 1 and Comparative Example 3, the content of iridium (% by weight) present in the catalyst layer of each of the manufactured electrodes was obtained using inductively coupled plasma atomic emission spectroscopy (ICP-AES, NexION 300×), and the results are shown in FIG. 9.

Referring to FIG. 9, the content of iridium present in the catalyst layer of the electrode of Example 1 was at the level of 0.47 mg/cm², confirming that the loading amount of iridium, an active metal, was significantly less compared to the electrode of Comparative Example 3, which had an iridium content of 1.7 mg/cm². Despite the significantly low iridium loading amount, the electrode of Example 1 may have superior activity compared to the electrode of Comparative Example 3, as will be described in Experimental Example 3 below.

### <Experimental Example 3>—Evaluation of Electrochemical Properties of Electrodes

The electrodes of Example 1, Comparative Example 1, Comparative Example 2, and Comparative Example 3 were used as a working electrode, Ag/AgCl (sat. 3 M KCl) was used as a reference electrode, and a graphite rod was used as a counter electrode to measure the polarization of the OER for the electrodes of Example 1, Comparative Example 1, Comparative Example 2, and Comparative Example 3. Each electrode was immersed into a 0.5 M H₂SO₄ acid solution, and OER was performed at a scan rate of 10 mV/s and room temperature.

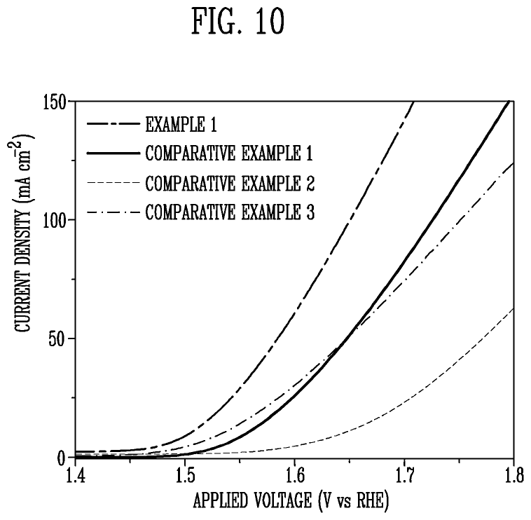

The polarization results for the OER are shown in FIG. 10 and Table 1 below, in which all the measurements were expressed as “vs reversible hydrogen electrode (RHE).”

TABLE 1

| | Overpotential |
|---|---|
| | (mV vs RHE; reference of current density: |
| | 10 mAcm⁻²) |
| Example 1 | 280 |
| Comparative Example 1 | 328 |
| Comparative Example 2 | 412 |
| Comparative Example 3 | 302 |

Referring to FIG. 10 and Table 1, it can be seen that with regard to the OER performance based on a current density of 10 mAcm⁻², the activity was good in the following order: Example 1, Comparative Example 3, Comparative Example 1, and Comparative Example 2.

In Example 1, an overpotential of only 280 mV was required to obtain a current density value of 10 mAcm⁻², which is a value 22 mV smaller than that of Comparative Example 3 and 48 mV smaller than that of Comparative Example 1.

As confirmed through the ICP analysis results of Example 1, it can be seen that although Example 1 had a significantly lower catalyst metal loading amount than that of Comparative Example 3, the OER performance of Example 1 was superior to Comparative Example 3.

In other words, it can be assumed that in the electrode of Example 1, as both iridium and palladium were deposited on a titanium mesh and interact with each other, the electronic structure of iridium, which was the active metal, was changed, and so the OER performance was significantly improved.

What is claimed is:

1. A catalyst electrode comprising:
a metal layer; and
a catalyst layer formed on the metal layer,
wherein the catalyst layer comprises iridium and palladium.

2. The catalyst electrode according to claim 1, wherein at least a part of the iridium and palladium comprised in the catalyst layer is chemically bonded with each other.

3. The catalyst electrode according to claim 1, wherein iridium contained in the catalyst layer at a loading amount ranging from 0.02 to 0.8 mg/cm², and palladium contained in the catalyst layer at a loading amount ranging from 0.1 to 0.9 mg/cm².

4. The catalyst electrode according to claim 1, wherein the metal layer comprises one or more selected from the group consisting of a metal mesh, metal foam, metal foil, metal felt, and a metal fiber.

5. The catalyst electrode according to claim 4, wherein the metal of the metal layer comprises one or more metals or metal alloy selected from the group consisting of titanium, nickel, and stainless steel.

6. The catalyst electrode according to claim 1, wherein the iridium and palladium are electrochemically deposited on the metal layer.

7. The catalyst electrode according to claim 1, wherein the iridium and palladium are in direct contact with the metal layer.

8. The catalyst electrode according to claim 7, wherein the catalyst layer does not comprise a binder.

9. A method for manufacturing a catalyst electrode, the method comprising a step of depositing iridium and palladium on a metal substrate.

10. The method according to claim 9, wherein the step of depositing iridium and palladium on a metal substrate comprises:
a step of inputting the metal substrate to a solution comprising an iridium precursor and a palladium precursor; and
a step of electrochemically depositing the iridium and palladium on the metal substrate.

11. The method according to claim 10, wherein at least a part of the iridium and palladium deposited on the metal substrate are chemically bonded with each other.

12. The method according to claim 10, wherein the step of electrochemically depositing the iridium and palladium on the metal substrate is performed by applying a voltage through one or more electrodes in contact with the solution.

13. The method according to claim 12, wherein the voltage is increased at a constant rate.

14. The method according to claim 9, further comprising: a step of heat-treating the metal substrate with the deposited iridium and palladium.

15. The method according to claim 9, further comprising a step of acid-treating the metal substrate before the step of depositing iridium and palladium on the metal substrate.

16. A membrane electrode assembly, comprising:
an electrolyte membrane;
an anode positioned on one surface of the electrolyte membrane; and
a cathode positioned on the other surface of the electrolyte membrane,
wherein the anode comprises:
a metal layer; and
a catalyst layer formed on the metal layer and comprising iridium and palladium.
